(19) United States
(12) Patent Application Publication
(10) Pub. No.: US 2019/0336400 A1
(43) Pub. Date: Nov. 7, 2019

(54) COUNTING DEVICE AND AUTOMATIC DISPENSING MACHINE USING COUNTING DEVICE

(71) Applicant: HON HAI PRECISION INDUSTRY CO., LTD., New Taipei (TW)

(72) Inventor: YU-TING WANG, New Taipei (TW)

(21) Appl. No.: 16/509,629

(22) Filed: Jul. 12, 2019

Related U.S. Application Data
(62) Division of application No. 15/636,896, filed on Jun. 29, 2017.

(30) Foreign Application Priority Data
May 10, 2017 (CN) 201710326422.1

(51) Int. Cl. A61J 7/04; B65D 23/00; A61J 7/02; B65D 83/04

(52) U.S. Cl. CPC A61J 7/04; B65D 23/008; B65D 83/04; B65D 83/0409; A61J 7/02

(57) ABSTRACT

A device to count the dispensing of objects such as pills by an automatic dispenser includes a base, a light emitting component installed on one end portion of the base, a light sensor installed on the other end portion of the base, a first lens, and a second lens. The light emitting component emits a point light ray towards the first lens, the point light ray is refracted into a parallel light ray and passes through the second lens, and is refracted again into the point light ray. The light sensor receives the reconverted point light ray and performs energy measurement to detect the dispensing of an object, the object as it passes having blocked a portion of the light ray.

### CROSS-REFERENCE TO RELATED APPLICATIONS

The subject matter herein generally relates to electronic cigarettes. This application is a divisional application of U.S. patent application Ser. No. 15/636,896, filed on Jun. 29, 2017, which claims priority to CN Patent Application with Serial Number 201710326422.1 filed on May 10, 2017, the disclosure of which is incorporated herein by reference.

### FIELD

The subject matter herein generally relates to a counting device and an automatic dispensing machine.

### BACKGROUND

When taking pill, the reliability of taking pill is an important factor in this institution. Therefore, it is necessary to be able to tell the patient whether it has succeeded in taking pill or repeated pill.

### BRIEF DESCRIPTION OF THE DRAWINGS

Implementations of the present technology will now be described, by way of example only, with reference to the attached figures.

FIG. 1 is an exploded view of an exemplary embodiment of a counting device.

FIG. 2 is similar to FIG. 1, but viewed from another angle.

FIG. 3 is a top view of the counting device of FIG. 1.

FIG. 4 is a diagram showing light moving direction of the counting device of FIG. 1, but without a pill passing through the pill channel.

FIG. 5 is a similar to FIG. 1, but a pill being passed through the pill channel.

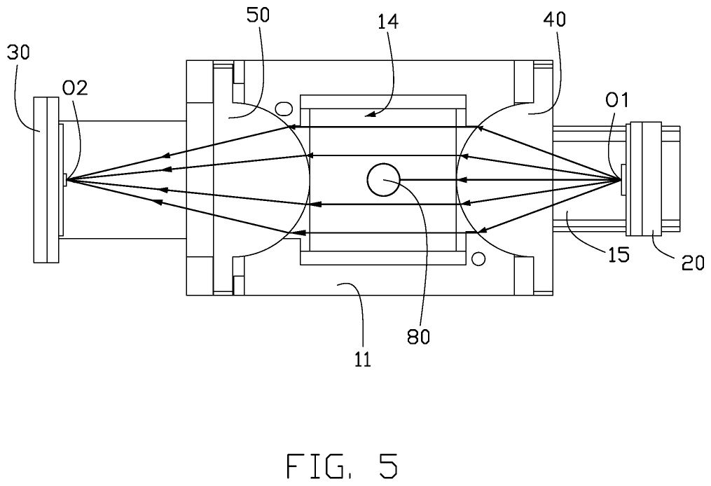

FIG. 6 is an exploded view of an exemplary embodiment of an automatic dispensing machine.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “outside” refers to a region that is beyond the outermost confines of a physical object. The term “inside” indicates that at least a portion of an object is contained within a boundary formed by another object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

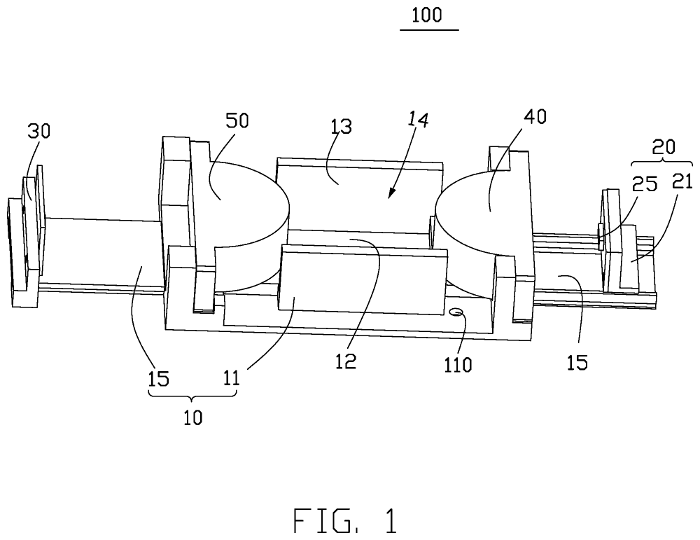

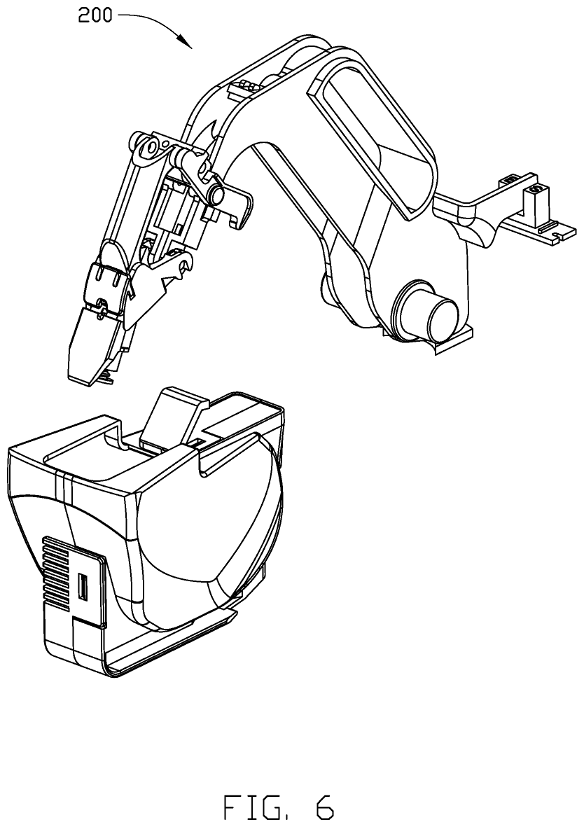

FIG. 1 and FIG. 6 illustrate one exemplary embodiment of a counting device 100 installed in an automatic dispensing machine 200. The counting device 100 is configured to determine the dispensing record of the automatic dispensing machine. The counting device 100 includes a base 10, a light emitting component 20, a light sensor 30, a first lens 40, and a second lens 50.

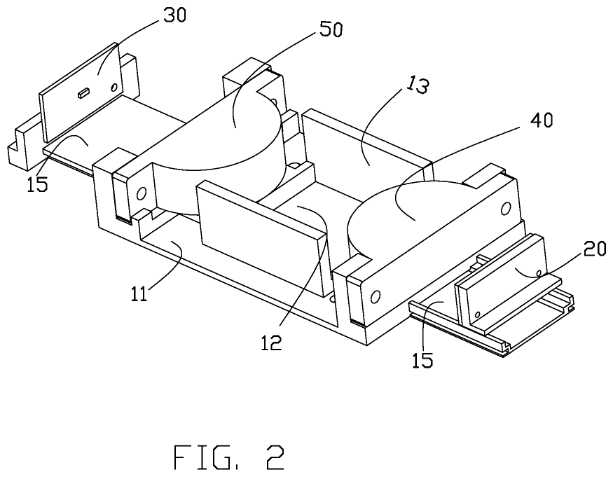

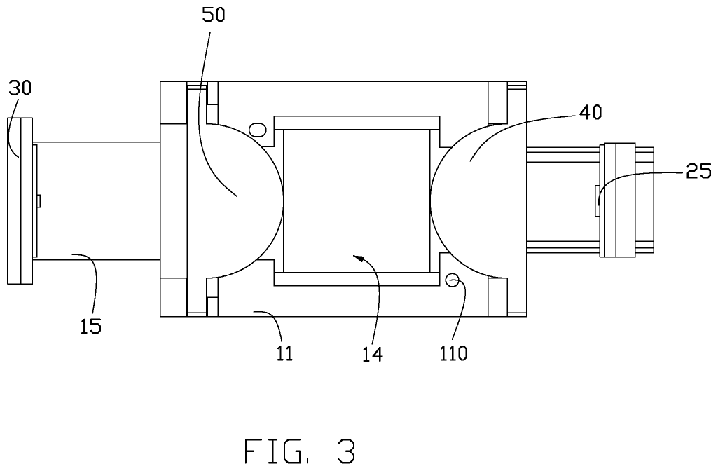

FIG. 1 to FIG. 3 illustrate that the base 10 includes a main body 11 and two mounting plates 15 respectively connected with ends of the main body 11. A middle portion of the main body 11 defines an opening 12, and includes two baffles 13 respectively located at both sides of the opening 12. The opening 12 and the two baffles 13 together form a pill channel 14, and the pills or other objects (pill 80) can pass through the pill channel 14. The main body 11 further defines a plurality of securing holes 110, and a plurality of fasteners (not shown) can pass through the securing holes 110 to secure the base 10 on the automatic dispensing machine 200.

The light emitting component 20 is secured to one of the mounting plates 15. The light emitting component 20 includes a shell 21 and a light source 25 installed on the shell 21. The light source 25 can emit light. The light sensor 30 is secured to another mounting plate 15. The light sensor 30 can receive light, which has been emitted and is not interrupted from the light source 25, and can determine whether or not a pill 80 passes based on the energy of light beam.

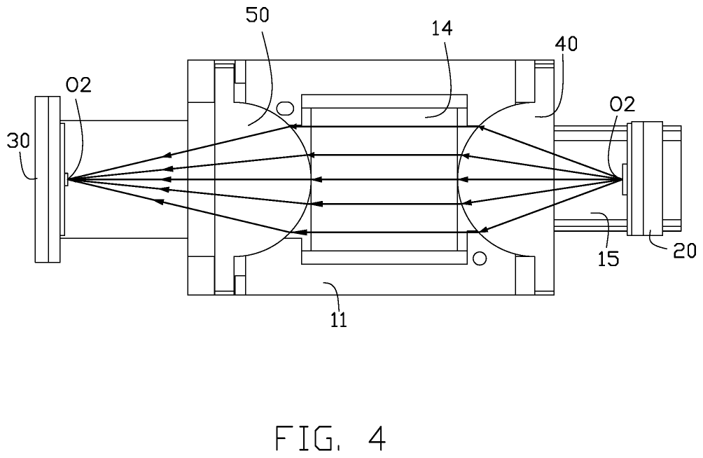

FIG. 1 and FIG. 4 illustrate that the first lens 40 and the second lens 50 are located at both end portions of the main body 11, and the pill channel 14 is located between the first lens 40 and the second lens 50. The first lens 40 is close to the light emitting component 20, and the second lens 50 is close to the light sensor 30. The first lens 40 has a first focal point O1, and the light source 25 of the light emitting component 20 is located at the first focal point O1. The first lens 40 turns a point light ray into a parallel light ray and cause the parallel light ray to pass through the pill channel 14. The second lens 50 has a second focal point O2, and the light sensor 30 is located at the second focal point O2. The second lens 50 reconverts the parallel light ray into a point light ray into the light sensor 30. In at least one embodiment, the first lens 40 is a collimating lens, and the second lens 50 is a focusing lens.

FIG. 4 illustrates assembly of the counting device 100. The light emitting component 20 is mounted to one of the mounting plates 15, and the light sensor 30 is mounted to the other mounting plate 15. The first lens 40 and the second lens 40 are mounted on both end portions of the main body 11, and the pill channel 14 is located between the first lens 40 and the second lens 50. Adjusting the first lens 40 and the second lens 50 such that the light emitting component 20 is located at the first focal point O1 of the first lens 40, the light sensor 30 is located at the second focal O2 of the second lens 50.

Then, the counting device 100 is assembled. The counting device 100 may then be installed in the automatic dispensing machine 200.

When the automatic dispensing machine 200 is operated, the counting device 100 is activated. The light source 25 of the light emitting component 20 emits a light ray toward the first lens 40, which passes through the first lens 40 and is refracted into a parallel light rat and passes through the drug passage 14. The parallel light ray is refracted into the light sensor 30 at the second focal point when it reaches the second lens 50 and is refracted into a point light ray. The light sensor 30 receives the point light ray and performs energy measurement.

When the pill 80 does not pass through the channel 14, the point light ray retains all its energy when injected into the light sensor 30. When one pill 80 does pass through the pill channel 14, the pill 80 blocks part of the light ray so that the light ray incident on the light sensor 30 is reduced and its energy is also reduced. At this time, the light sensor 30 is able to determine that a pill 80 passes through the pill channel 14. That is, the automatic dispensing machine 200 has dispensed a pill 80. The outlet of the automatic dispensing machine 200 is directly in contact with a patient's mouth, if the pill passes through the counting device 100, then the pill must exit through the outlet and into the patient's mouth. Thus, the automatic dispensing machine 200 can determine that the pill has been taken by the patient.

The exemplary embodiments shown and described above are only examples. Many details are often found in the art such as the other features of a counting device and an automatic dispensing machine. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An automatic dispensing machine, comprising:
a counting device, comprising:
a base;
a light emitting component installed on one end portion of the base;
a light sensor installed on the other end portion of the base;
a first lens; and
a second lens;
wherein the light emitting component emits a point light ray towards the first lens, the point light ray passes through the first lens and the second lens, the light sensor receives the point light ray and determine whether pill passes through the counting device by measuring energy of the point light ray.

2. The automatic dispensing machine of claim 1, wherein the base comprises a main body, the first lens and the second lens are mounted on two portions of the main body.

3. The automatic dispensing machine of claim 2, wherein the base further comprises two mounting plates respectively mounted at two portions of the main body, the light emitting component and the light sensor are respectively mounted on the two mounting plates.

4. The automatic dispensing machine of claim 1, wherein the first lens has a first focal point, the light emitting component comprises a light source, and the light source is located at the first focal point.

5. The automatic dispensing machine of claim 1, wherein the second lens has a second focal point, and the light sensor is located at the second focal point.

6. The automatic dispensing machine of claim 1, wherein the base defines an opening, the base comprises two baffles respectively located at two sides of the opening, the opening and the two baffles together define a pill channel.

7. The automatic dispensing machine of claim 1, wherein the first lens is a collimating lens.

8. The automatic dispensing machine of claim 1, wherein the second lens is a focusing lens.
